(19) United States
(12) Patent Application Publication
(10) Pub. No.: US 2025/0192698 A1
(43) Pub. Date: Jun. 12, 2025

(54) VIBRATION WAVE MOTOR AND DRIVING APPARATUS

(71) Applicant: CANON KABUSHIKI KAISHA, Tokyo (JP)

(72) Inventor: AKIRA SHIMADA, Saitama (JP)

(21) Appl. No.: 19/054,664

(22) Filed: Feb. 14, 2025

Related U.S. Application Data
(63) Continuation of application No. PCT/JP2023/029202, filed on Aug. 10, 2023.

(30) Foreign Application Priority Data
Sep. 1, 2022 (JP) 2022-139298

(51) Int. Cl. H02N 2/10; G02B 7/04

(52) U.S. Cl. CPC H02N 2/103; G02B 7/04

(57) ABSTRACT

In a vibration wave motor that includes a first elastic body and a second elastic body, a piezoelectric element (electromechanical energy conversion element) sandwiched between the first elastic body and the second elastic body, and a contact body configured to come into pressure contact with the first elastic body, an outer shape of a cross-section (XY plane) in the piezoelectric element perpendicular to a pressure direction (Z direction) in pressure contact between the first elastic body and the contact body is a rectangle, and vertices of the rectangle of the piezoelectric element are not in contact with the first elastic body.

### CROSS-REFERENCE TO RELATED APPLICATIONS

This application is a Continuation of International Patent Application No. PCT/JP2023/029202, filed Aug. 10, 2023, which claims the benefit of Japanese Patent Application No. 2022-139298, filed Sep. 1, 2022, both of which are hereby incorporated by reference herein in their entirety.

### BACKGROUND OF THE INVENTION

### Field of the Invention

The present invention relates to a vibration wave motor and a driving apparatus including the vibration wave motor.

### Background Art

Various configurations of a vibration wave motor that uses an electromechanical energy conversion element such as a piezoelectric element are known. For example, there is known a vibration wave motor that performs driving by bringing a rotor into pressure contact with a Langevin vibrator configured by sandwiching the piezoelectric element by elastic bodies made of stainless steel and the like. The driving principle is that elliptical motion or circular motion is generated on surfaces of the elastic bodies by generating two bending vibrations orthogonal to each other on the vibrator by application of a predetermined alternating-current voltage (also referred to as “driving voltage”) to the piezoelectric element, and the rotor is rotationally moved by frictional force.

For example, the piezoelectric element includes a stacked body in order to obtain larger driving force, and has a ring-shaped columnar configuration. The piezoelectric element including the stacked body is manufactured through various steps. In particular, it is necessary to perform processing of an outer diameter after sintering, and the processing of the outer diameter requires special facilities, which causes increase in manufacturing cost.

Patent Literature 1 discusses a vibrator that includes a piezoelectric element as an electromechanical energy conversion element having a polygonal cross-section orthogonal to an axis direction, and paired metal elastic bodies each having a circular cross-section orthogonal to the axis direction. More specifically, Patent Literature 1 discusses a rod-shaped vibrator in which the piezoelectric element is disposed between the paired metal elastic bodies, the metal elastic bodies are fastened by a fastening member to sandwich and fix the piezoelectric element between the metal elastic bodies. Further, in Patent Literature 1, the piezoelectric element is formed in a rectangle (more specifically, square). Therefore, the piezoelectric element cut out from a sheet can be used as it is (effort for outer shape processing can be eliminated). This makes it possible to reduce the manufacturing cost.

In Patent Literature 2, four divided parts of an inner-layer electrode of the piezoelectric element formed in a rectangle (more specifically, square) are disposed at positions including respective vertices of the rectangle of the piezoelectric element. This makes it possible to generate larger force as compared with a case where the four divided parts of the inner-layer electrode are disposed at positions not including the vertices.

### CITATION LIST

### Patent Literature

PTL 1: Japanese Patent Laid-Open No. 2003-47266
PTL 1: Japanese Patent Laid-Open No. 2006-179578

However, there is an issue that, only by changing the shape of the piezoelectric element as the electromechanical energy conversion element from a circle to a rectangle (e.g., square) as in the existing technique, power is increased. This is because, for example, in a case where the piezoelectric element is formed in a square as with the piezoelectric element discussed in Patent Literature 2, a distance from an axial center in a radial direction is V2 times larger than in a case where the piezoelectric element is formed in a circle, pressure is increased toward an outer diameter side, and the vibrator cannot be efficiently vibrated.

### SUMMARY OF THE INVENTION

The present invention is made in consideration of such issues, and is directed to a vibration wave motor that can efficiently perform vibration while reducing a manufacturing cost.

A vibration wave motor according to the present invention includes a first elastic body and a second elastic body, an electromechanical energy conversion element sandwiched between the first elastic body and the second elastic body, and a contact body configured to come into pressure contact with the first elastic body. In the electromechanical energy conversion element, an outer shape of a cross-section perpendicular to a pressure direction in pressure contact is a rectangle. Vertices of the rectangle of the electromechanical energy conversion element are not in contact with the first elastic body. Further, the present invention includes a driving apparatus including the above-described vibration wave motor.

Further features of the present invention will become apparent from the following description of exemplary embodiments with reference to the attached drawings.

### BRIEF DESCRIPTION OF THE DRAWINGS

FIG. 1 is an exploded diagram of a vibration wave motor according to a first exemplary embodiment of the present invention.

FIG. 2 is a cross-sectional view of the vibration wave motor according to the first exemplary embodiment of the present invention.

FIG. 3A is a diagram illustrating a vibration mode in a vibrator of the vibration wave motor according to the first exemplary embodiment of the present invention.

FIG. 3B is a diagram illustrating the vibration mode in the vibrator of the vibration wave motor according to the first exemplary embodiment of the present invention.

FIG. 3C is a diagram illustrating the vibration mode in the vibrator of the vibration wave motor according to the first exemplary embodiment of the present invention.

FIG. 4 is an enlarged view of a predetermined region in a cross-section of the vibration wave motor illustrated in FIG. 2.

FIG. 5A is a diagram illustrating an outer shape of a contact surface of a first elastic body with a piezoelectric element and an outer shape of a contact surface of a second elastic body with a flexible printed board according to the first exemplary embodiment of the present invention, as viewed from an axis direction of the vibrator (Z direction).

FIG. 5B is a diagram illustrating the outer shape of the contact surface of the first elastic body with the piezoelectric element and the outer shape of the contact surface of the second elastic body with the flexible printed board according to the first exemplary embodiment of the present invention, as viewed from the axis direction of the vibrator (Z direction).

FIG. 6 is a cross-sectional view of a cross-section (XY plane) of the piezoelectric element perpendicular to the axis direction of the vibrator (Z direction) according to the first exemplary embodiment of the present invention.

FIG. 7 is a characteristic diagram illustrating actually-measured relationship between a speed (rotation speed) of the vibration wave motor and power in a case where gaps illustrated in FIG. 4 are provided and in a case where the gaps illustrated in FIG. 4 are not provided.

FIG. 8A is a diagram illustrating an outer shape of a contact surface of a first elastic body with a piezoelectric element according to a second exemplary embodiment of the present invention, as viewed from an axis direction of a vibrator (Z direction).

FIG. 8B is a diagram illustrating the outer shape of the contact surface of the first elastic body with the piezoelectric element according to the second exemplary embodiment of the present invention, as viewed from the axis direction of the vibrator (Z direction).

FIG. 9A is a cross-sectional view of a cross-section (XY plane) of a piezoelectric element perpendicular to an axis direction of a vibrator (Z direction) according to a third exemplary embodiment.

FIG. 9B is a cross-sectional view of the cross-section (XY plane) of the piezoelectric element perpendicular to the axis direction of the vibrator (Z direction) according to the third exemplary embodiment.

FIG. 9C is a cross-sectional view of the cross-section (XY plane) of the piezoelectric element perpendicular to the axis direction of the vibrator (Z direction) according to the third exemplary embodiment.

FIG. 10A is a diagram illustrating an example of a schematic configuration of an imaging apparatus applied as a driving apparatus according to a fourth exemplary embodiment of the present invention.

FIG. 10B is a diagram illustrating an example of the schematic configuration of the imaging apparatus applied as the driving apparatus according to the fourth exemplary embodiment of the present invention.

### DESCRIPTION OF THE EMBODIMENTS

Some embodiments (exemplary embodiments) for implementing the present invention are described below with reference to drawings.

### First Exemplary Embodiment

First, a first exemplary embodiment of the present invention is described.

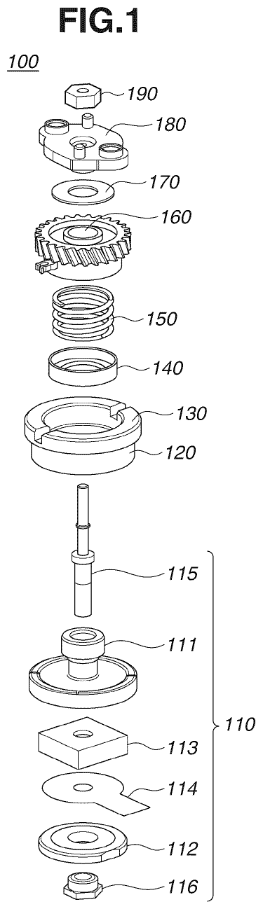

FIG. 1 is an exploded diagram of a vibration wave motor 100 according to the first exemplary embodiment of the present invention.

As illustrated in FIG. 1, the vibration wave motor 100 includes a rod-shaped vibrator 110, a contact body 120, a rotor main ring 130, a rubber 140, a pressure spring 150, a gear 160, a flange cap 170, a flange 180, and a nut 190.

As illustrated in FIG. 1, the rod-shaped vibrator 110 includes a first elastic body 111, a second elastic body 112, a piezoelectric element (electromechanical energy conversion element) 113, a flexible printed board 114, a shaft 115, and a nut 116. The rod-shaped vibrator 110 is configured in such a manner that the shaft 115 and the nut 116 fasten the first elastic body 111, the second elastic body 112, the piezoelectric element 113, and the flexible printed board 114 so as to apply predetermined holding force.

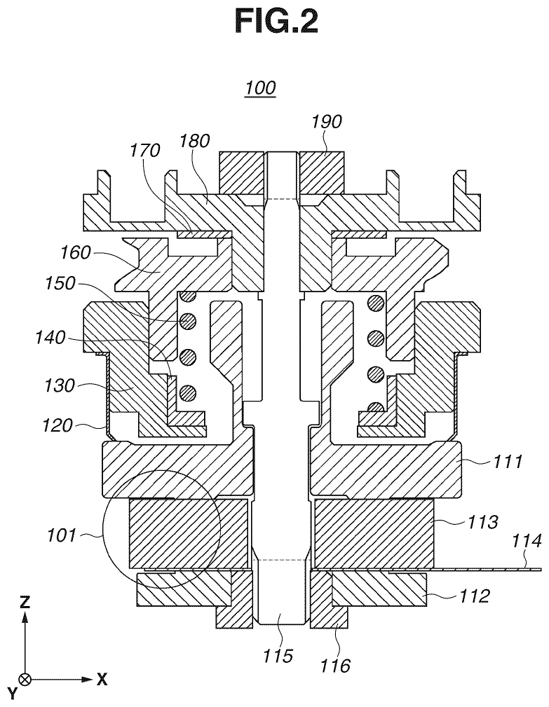

FIG. 2 is a cross-sectional view of the vibration wave motor 100 according to the first exemplary embodiment of the present invention. In FIG. 2, components similar to the components illustrated in FIG. 1 are denoted by the same reference numerals. FIG. 2 illustrates an XYZ coordinate system in order to facilitate understanding of positions of the respective components of the vibration wave motor 100. In the following, a schematic configuration and a basic principle of the vibration wave motor 100 according to the first exemplary embodiment are described with reference to FIG. 1 and FIG. 2.

The piezoelectric element 113 includes electrode groups (A-phase and B-phase) each including two electrodes. Alternating-current voltages (alternating-current electric fields) different in phase are applied to the electrode groups from a power supply (not illustrated) through the flexible printed board 114. As a result, two bending vibrations orthogonal to each other are excited on the vibrator 110.

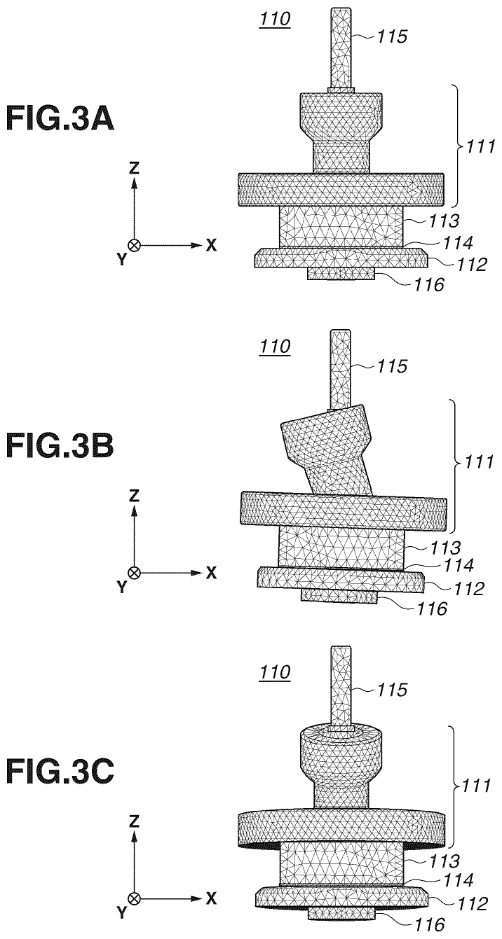

FIG. 3A to FIG. 3C are diagrams illustrating a vibration mode in the vibrator 110 of the vibration wave motor 100 according to the first exemplary embodiment of the present invention. In FIG. 3A to FIG. 3C, components similar to the components illustrated in FIG. 1 are denoted by the same reference numerals. Further, FIG. 3A to FIG. 3C illustrate an XYZ coordinate system corresponding to the XYZ coordinate system illustrated in FIG. 2. More specifically, FIG. 3A illustrates a state where no voltage is applied to the vibrator 110. FIG. 3B illustrates a vibration mode in which bending occurs in an X direction (right-left direction on paper surface) in the vibrator 110. FIG. 3C illustrates a vibration mode in which bending occurs in a Y direction (perpendicular direction on paper surface) in the vibrator 110.

Further, by adjusting phases of the alternating-current voltages (alternating-current electric fields) applied to the piezoelectric element 113, a temporal phase difference by 90 degrees can be imparted to the two vibration modes that are shifted in spatial phase around the axis direction of the vibrator 110, by 90 degrees. As a result, bending vibration of the vibrator 110 rotates around the axis, and elliptical motion occurs on the first elastic body 111. When the contact body 120 is brought into pressure contact with the first elastic body 111, the contact body 120 and the rotor main ring 130 to which the contact body 120 is fixed, and the gear 160 integrally rotate around the axis by frictional force. In the present exemplary embodiment, a pressure direction in pressure contact between the first elastic body 111 and the contact body 120 is the Z direction.

In the present exemplary embodiment, the piezoelectric element 113 is assumed to be a stacked piezoelectric element formed by alternatively stacking a plurality of piezoelectric layers and electrode layers and simultaneously sintering the layers; however, the piezoelectric element 113 may have a configuration in which a plurality of single-plate piezoelectric elements is stacked and sandwiched by elastic bodies. In the present exemplary embodiment, a sensor phase for monitoring a vibration state of the vibrator 110 is provided on a part of the A-phase of the piezoelectric element 113. The vibration state of the vibrator 110 is monitored by detecting charges generated due to distortion by the bending vibration of the vibrator 110, namely, charges generated by a positive piezoelectric effect. The relationship of a phase difference between the voltage applied to the A-phase piezoelectric element and an output signal of the sensor phase to a frequency at this time is 90 degrees at a resonance frequency, and is gradually shifted as the frequency is increased from the resonance frequency. Therefore, when the value of the phase difference is detected while vibration is excited, relationship between an input frequency and the resonance frequency of the vibrator 110 can be monitored, and stable driving can be performed.

As illustrated in FIG. 2, a lower end surface of the contact body 120 comes into (pressure) contact with the first elastic body 111. The contact body 120 is fixed to the rotor main ring 130, and the contact body 120 and the rotor main ring 130 integrally rotate. The contact body 120 has a small contact area with the first elastic body 111 and has appropriate spring property. As a material of the contact body 120, stainless steel having wear resistance, strength, and corrosion resistance is preferable, and SUS420J2 is more preferable. The contact body 120 made of such a material can be processed by a turning process, a three-dimensional (3D) printer, or the like; however, press processing is preferable in terms of processing accuracy and a cost. The contact body 120 is fixed to the rotor main ring 130 by adhesion with a resin adhesive, metal brazing with solder or the like, welding such as laser welding or resistance welding, or mechanical joining such as press-fitting or crimping.

The rotor main ring 130 is pressurized by the pressure spring 150 through the rubber 140. When the rotor main ring 130 is pressurized in such a manner, frictional force is generated between the contact body 120 and the first elastic body 111, and the contact body 120 can be rotated by the above-described elliptical motion. The rubber 140 has a function of reducing unnecessary vibration of the pressure spring 150 while uniformizing pressing force.

As illustrated in FIG. 2, the gear 160 transmitting an output to an outside is provided on an upper surface of the rotor main ring 130. Further, as illustrated in FIG. 1, a concave part engaging with a convex part provided on the gear 160 is provided on the upper surface of the rotor main ring 130. When the convex part of the gear 160 engages with the concave part provided on the upper surface of the rotor main ring 130, the gear 160 rotates together with the rotor main ring 130, and transmits the output of the vibration wave motor 100 to the outside. The gear 160 slides while receiving pressure. Therefore, the gear 160 is preferably made of a material satisfying strength and wear resistance. In addition, in consideration of a cost and quiet performance, the gear 160 is most preferably made of a reinforcement fiber-containing resin.

The vibrator 110 is fixed to the flange 180 as a fixing member, by the shaft 115 and the nut 190. The flange cap 170 as a pressure receiving member is provided between the gear 160 and the flange 180. The flange cap 170 may be fixed to the flange 180 with an adhesive or the like. As a material of the flange cap 170, a material having wear resistance is preferable. The flange cap 170 is more preferably formed by press processing of stainless steel because high dimensional accuracy and high productivity are achievable. The flange 180 is preferably formed by resin molding, zinc die casting, aluminum die casting, or metal sintering because the flange 180 has a complicated shape. In the present exemplary embodiment, the flange 180 is more preferably formed by zinc die casting that is excellent in balance of dimensional accuracy and a cost. In the present exemplary embodiment, the gear 160 and the flange cap 170 slide in the axial direction of the vibrator 110 (arrangement direction of shaft 115: Z direction), and the gear 160 and the flange 180 slide in a radial direction, to serve as sliding bearings.

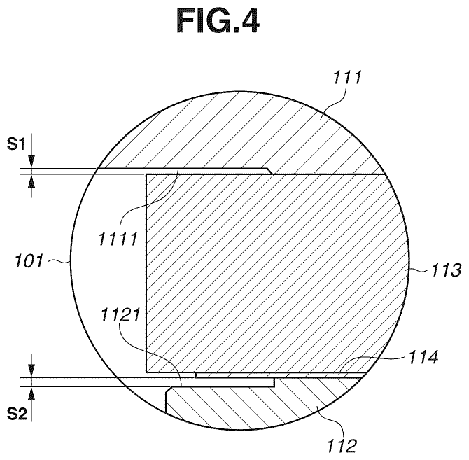

FIG. 4 is an enlarged view of a predetermined region 101 in a cross-section of the vibration wave motor 100 illustrated in FIG. 2. In FIG. 4, components similar to the components illustrated in FIG. 2 are denoted by the same reference numerals.

As illustrated in FIG. 4, a gap S1 extending from an axial center to an outer diameter side is provided between the first elastic body 111 and the piezoelectric element 113. More specifically, the first elastic body 111 illustrated in FIG. 4 includes a first surface 1111 including the gap S1 between the first elastic body 111 and the piezoelectric element 113, in an outer-shape neighborhood region of an outer shape of the piezoelectric element 113 on the piezoelectric element 113 side.

As illustrated in FIG. 4, a gap S2 is provided between the flexible printed board 114 and the second elastic body 112. More specifically, the second elastic body 112 illustrated in FIG. 4 includes a second surface 1121 including the gap S2 between the second elastic body 112 and the flexible printed board 114, in the outer-shape neighborhood region of the outer shape of the piezoelectric element 113 on the flexible printed board 114 side.

Suitable sizes of the gap S1 and the gap S2 illustrated in FIG. 4 are described below.

When the sizes of the gap S1 and the gap S2 are excessively small, the gap S1 and the gap S2 are filled due to variation in manufacture, deformation when the piezoelectric element 113 is sandwiched by the elastic bodies 111 and 112, and displacement in driving. Therefore, the size of each of the gap S1 and the gap S2 is desirably 20 μm or more. When the sizes of the gap S1 and the gap S2 are excessively large, the vibration mode is changed from a desired mode, and driving efficiency is lowered. Therefore, the size of each of the gap S1 and the gap S2 is desirably 200 μm or less. Accordingly, the size of each of the gap S1 and the gap S2 illustrated in FIG. 4 is preferably 20 μm or more and 200 μm or less.

In the example illustrated in FIG. 4, the gap S1 is secured by forming the first surface 1111 including a step on a surface of the first elastic body 111; however, the present invention is not limited to the form. For example, a form in which a thin plate (first plate) having a thickness of 20 μm or more and 200 μm or less corresponding to the gap S1 is provided between the first elastic body 111 and the piezoelectric element 113 also achieves an effect similar to the effect in the above-described case where the gap S1 is provided, and is applicable to the present invention.

In the example illustrated in FIG. 4, the gap S2 is secured by forming the second surface 1121 including a step on a surface of the second elastic body 112; however, the present invention is not limited to the form. For example, a form in which a thin plate (second plate) having a thickness of 20 μm or more and 200 μm or less corresponding to the gap S2 is provided between the flexible printed board 114 and the second elastic body 112 also achieves an effect similar to the effect in the above-described case where the gap S2 is provided, and is applicable to the present invention.

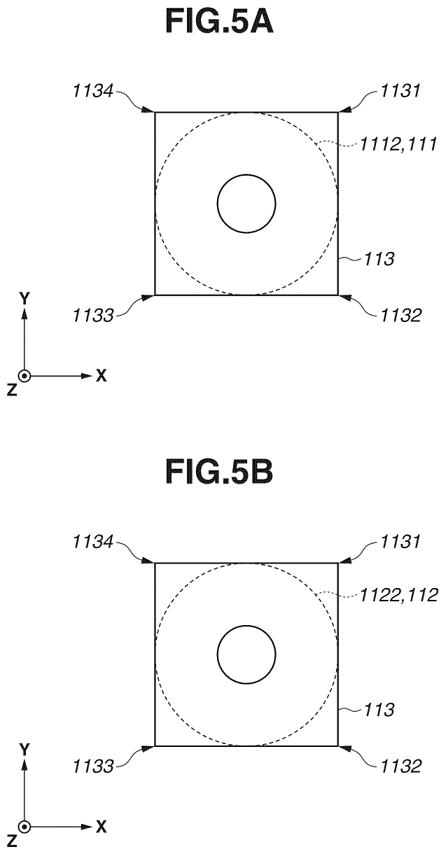

FIG. 5A and FIG. 5B are diagrams respectively illustrating an outer shape of a contact surface of the first elastic body 111 with the piezoelectric element 113 and an outer shape of a contact surface of the second elastic body 112 with the flexible printed board 114 according to the first exemplary embodiment of the present invention, as viewed from the axis direction of the vibrator 110 (Z direction). In FIG. 5A and FIG. 5B, components similar to the components illustrated in FIG. 2 and FIG. 4 are denoted by the same reference numerals. Further, FIG. 5A and FIG. 5B illustrate an XYZ coordinate system corresponding to the XYZ coordinate system illustrated in FIG. 2.

More specifically, FIG. 5A is a diagram illustrating an outer shape 1112 (illustrated by dotted line) of the contact surface of the first elastic body 111 with the piezoelectric element 113 illustrated in FIG. 2 and FIG. 4, and the piezoelectric element 113 (illustrated by solid line), as viewed from the Z direction. As viewed from the Z direction, the outer shape of the piezoelectric element 113 is a rectangle (more specifically, square) having four vertices 1131 to 1134. In the present exemplary embodiment, as viewed from the Z direction, the outer shape 1112 of the contact surface of the first elastic body 111 with the piezoelectric element 113 is a circle inscribed in the piezoelectric element 113. Further, in the present exemplary embodiment, as illustrated in FIG. 5A, the outer shape 1112 of the contact surface of the first elastic body 111 with the piezoelectric element 113 is on the inside of the vertices 1131 to 1134 of the rectangle of the piezoelectric element 113. This indicates that, in the present exemplary embodiment, the first elastic body 111 is not in contact with the vertices 1131 to 1134 of the rectangle of the piezoelectric element 113. Accordingly, even in a case where the piezoelectric element 113 is formed in a rectangle in terms of reduction of the above-described manufacturing cost, a radial-direction distance from the axial center on the contact surface between the piezoelectric element 113 and the first elastic body 111 can be reduced, and the vibrator 110 can be efficiently vibrated.

In the case of the form in which the above-described first thin plate is provided between the first elastic body 111 and the piezoelectric element 113, a form in which the first thin plate is not in contact with the vertices 1131 to 1134 of the rectangle of the piezoelectric element 113 is adopted.

FIG. 5B is a diagram illustrating an outer shape 1122 (illustrated by dotted line) of the contact surface of the second elastic body 112 with the flexible printed board 114 illustrated in FIG. 2 and FIG. 4, and the piezoelectric element 113 (illustrated by solid line), as viewed from the Z direction. As in FIG. 5A, as viewed from the Z direction, the outer shape of the piezoelectric element 113 is a rectangle (more specifically, square) having the four vertices 1131 to 1134. In the present exemplary embodiment, as viewed from the Z direction, the outer shape 1122 of the contact surface of the second elastic body 112 with the flexible printed board 114 is a circle inscribed in the piezoelectric element 113. Further, in the present exemplary embodiment, as illustrated in FIG. 5B, the outer shape 1122 of the contact surface of the second elastic body 112 with the flexible printed board 114 is on the inside of the vertices 1131 to 1134 of the rectangle of the piezoelectric element 113. As illustrated in FIG. 2, FIG. 4, and FIG. 5B, the second elastic body 112 is not in contact with the vertices 1131 to 1134 of the rectangle of the piezoelectric element 113.

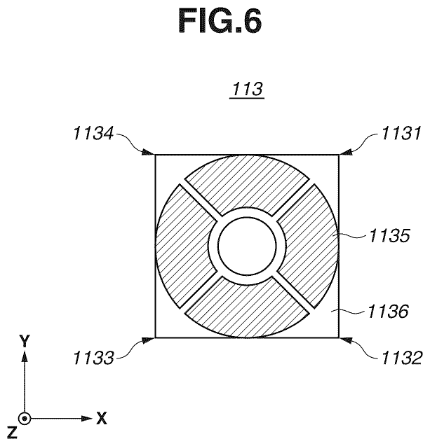

FIG. 6 is a cross-sectional view of a cross-section (XY plane) of the piezoelectric element 113 perpendicular to the axis direction of the vibrator 110 (Z direction) according to the first exemplary embodiment of the present invention. In FIG. 6, components similar to the components illustrated in FIG. 2, FIG. 5A, and FIG. 5B are denoted by the same reference numerals. FIG. 6 illustrates an XYZ coordinate system corresponding to the XYZ coordinate system illustrated in FIG. 2, FIG. 5A, and FIG. 5B.

As illustrated in FIG. 6, the piezoelectric element 113 includes an inner-layer electrode 1135 (illustrated by hatched lines), and a non-electrode portion 1136 not including the inner-layer electrode 1135. In the present exemplary embodiment, the inner-layer electrode 1135 is disposed while being divided into four parts by diagonal lines connecting the vertices 1131 to 1134 of the rectangle of the piezoelectric element 113. In the piezoelectric element 113, a portion provided with the inner-layer electrode 1135 is polarized. Therefore, the portion serves as an active portion generating displacement by application of a voltage. On the other hand, in the piezoelectric element 113, the non-electrode portion 1136 not including the inner-layer electrode 1135 is not polarized. Therefore, the non-electrode portion 1136 serves as an inactive portion not generating displacement even when a voltage is applied to the piezoelectric element 113. In other words, in the present exemplary embodiment, a neighborhood region including the vertices 1131 to 1134 of the rectangle of the piezoelectric element 113 is not polarized. Essentially, a through-hole electrode is disposed in order to make the inner-layer electrode 1135 conductive; however, illustration of the through-hole electrode is omitted in FIG. 6. In a case where the piezoelectric element 113 is a stacked piezoelectric element, the inner-layer electrode 1135 and a piezoelectric body are generally integrally sintered. Therefore, as a material of the inner-layer electrode 1135, it is necessary to use an expensive noble metal having high heat-resisting temperature, such as platinum and a palladium-silver alloy. On this issue, in the present exemplary embodiment, as illustrated in FIG. 6, the inner-layer electrode 1135 is not provided over the entire rectangle of the piezoelectric element 113, to minimize the electrode material cost.

However, in this state, the non-electrode portion 1136 that is the inactive portion not contributing to vibration comes into contact with the first elastic body 111 and the second elastic body 112, and accordingly, the vibration efficiency may be deteriorated. Therefore, in the present exemplary embodiment, a size of an outer diameter of the inner-layer electrode 1135 of the piezoelectric element 113 illustrated in FIG. 6, and sizes of outer diameters of the outer shapes 1112 and 1122 illustrated in FIG. 5A and FIG. 5B are defined as follows. More specifically, in the present exemplary embodiment, the size of the outer diameter of the inner-layer electrode 1135 (at least one part of inner-layer electrode 1135) illustrated in FIG. 6 is made coincident with the size of the outer diameter of the outer shape 1112 of the contact surface of the first elastic body 111 with the piezoelectric element illustrated in FIG. 5A. In addition, in the present exemplary embodiment, the size of the outer diameter of the inner-layer electrode 1135 (at least one part of inner-layer electrode 1135) illustrated in FIG. 6 is made coincident with the size of the outer diameter of the outer shape 1122 of the contact surface of the second elastic body 112 with the flexible printed board 114 illustrated in FIG. 5B. As a result, in the present exemplary embodiment, the non-electrode portion 1136 as the inactive portion does not come into contact with the first elastic body 111 and the second elastic body 112 even though the non-electrode portion 1136 is present in the neighborhood region including the vertices 1131 to 1134 of the piezoelectric element 113. This makes it possible to efficiently vibrate the vibrator 110.

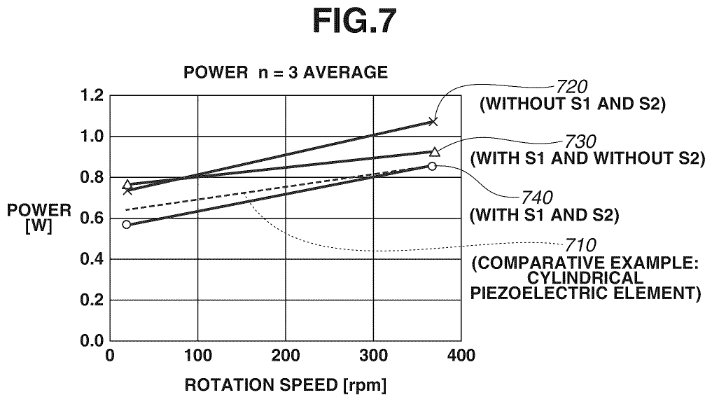

FIG. 7 is a characteristic diagram illustrating an actually-measured relationship between a speed (rotation speed) of the vibration wave motor and power in a case where the gap S1 and the gap S2 illustrated in FIG. 4 are provided and in a case where the gap S1 and the gap S2 illustrated in FIG. 4 are not provided.

Characteristics 710 illustrated by a dotted line in FIG. 7 indicate a relationship between a speed (rotation speed) of a vibration wave motor using a cylindrical piezoelectric element according to a comparative example and power. In the vibration wave motor using the cylindrical piezoelectric element according to the comparative example, excellent power is achieved, but a manufacturing cost is increased because rounding processing is necessary as outer shape processing for the cylindrical piezoelectric element.

Characteristics 720 illustrated by a line with cross marks at both ends in FIG. 7 indicate relationship between a speed (rotation speed) of a vibration wave motor without the gap S1 and the gap S2 illustrated in FIG. 4 according to a comparative example and power. As understood from the characteristics 720, power becomes the highest in the vibration wave motor without the gap S1 and the gap S2 according to the comparative example.

Characteristics 730 illustrated by a line with triangle marks at both ends in FIG. 7 indicate a relationship between a speed (rotation speed) of a vibration wave motor with the gap S1 and without the gap S2 illustrated in FIG. 4 according to an example of the exemplary embodiment of the present invention and power. In the characteristics 730, power is improved as compared with the characteristics 720.

Characteristics 740 illustrated by a line with circle marks at both ends in FIG. 7 indicate a relationship between a speed (rotation speed) of a vibration wave motor with the gap S1 and the gap S2 illustrated in FIG. 4 according to an example of the exemplary embodiment of the present invention and power. The characteristics 740 achieve power equivalent to or less than the power in the characteristics 710 of the vibration wave motor using the cylindrical piezoelectric element according to the comparative example.

The vibration wave motor 100 according to the first exemplary embodiment described above includes the first elastic body 111 and the second elastic body 112, the piezoelectric element 113 sandwiched between the first elastic body 111 and the second elastic body 112, and the contact body 120 coming into pressure contact with the first elastic body 111. The piezoelectric element 113 is an electromechanical energy conversion element. In the vibration wave motor 100 according to the first exemplary embodiment, in the piezoelectric element 113, the outer shape of the cross-section (XY plane) perpendicular to the pressure direction (Z direction or axial direction of vibrator 110) in pressure contact between the first elastic body 111 and the contact body 120 is a rectangle. In addition, in the vibration wave motor 100 according to the first exemplary embodiment, the vertices 1131 to 1134 of the rectangle of the piezoelectric element 113 are not in contact with the first elastic body 111.

With such a configuration, it is possible to provide the vibration wave motor that can efficiently perform vibration (with high driving efficiency) while reducing the manufacturing cost.

Further, in the vibration wave motor 100 according to the first exemplary embodiment, the vertices 1131 to 1134 of the rectangle of the piezoelectric element 113 are not in contact with the second elastic body 112.

With such a configuration, it is possible to provide the vibration wave motor that can more efficiently perform vibration (with higher driving efficiency) while reducing the manufacturing cost.

### Second Exemplary Embodiment

A second exemplary embodiment is described. In description of the second exemplary embodiment described below, description of matters in common with the above-described first exemplary embodiment is omitted, and matters different from the above-described first exemplary embodiment are mainly described.

In the above-described first exemplary embodiment, the outer shape 1112 of the contact surface of the first elastic body 111 with the piezoelectric element 113 illustrated in FIG. 5A is the circle inscribed in the piezoelectric element 113. In the second exemplary embodiment, the outer shape 1112 different from the shape in the first exemplary embodiment is described.

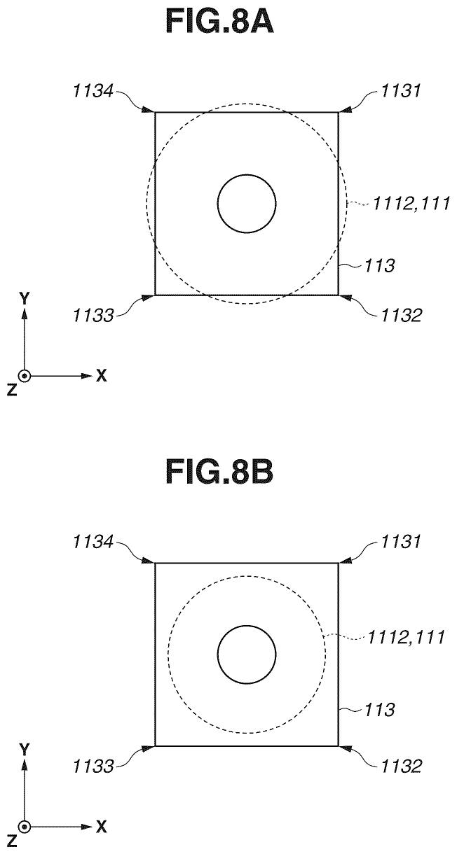

FIG. 8A and FIG. 8B are diagrams illustrating an outer shape of a contact surface of the first elastic body 111 with the piezoelectric element 113 according to the second exemplary embodiment of the present invention, as viewed from the axis direction of the vibrator 110 (Z direction). In FIG. 8A and FIG. 8B, components similar to the components illustrated in FIG. 5A are denoted by the same reference numerals. Further, FIG. 8A and FIG. 8B illustrate an XYZ coordinate system corresponding to the XYZ coordinate system illustrated in FIG. 5A. More specifically, FIG. 8A and FIG. 8B are diagrams illustrating the outer shape 1112 (illustrated by dotted line) of the contact surface of the first elastic body 111 with the piezoelectric element 113 illustrated in FIG. 2 and FIG. 4, and the piezoelectric element 113 (illustrated by solid line), as viewed from the Z direction.

First, in a first example of the second exemplary embodiment illustrated in FIG. 8A, the outer shape 1112 of the contact surface of the first elastic body 111 with the piezoelectric element 113 is a circle, and an outer diameter of the circle is longer than a length of one side of a rectangle (more specifically, square) that is the outer shape of the piezoelectric element 113. Further, as illustrated in FIG. 8A, the circle that is the outer shape 1112 of the contact surface of the first elastic body 111 with the piezoelectric element 113 is on the inside of the vertices 1131 to 1134 of the rectangle that is the outer shape of the piezoelectric element 113. In the case of the first example of the second exemplary embodiment, it is necessary to increase the outer diameter of the inner-layer electrode 1135 such that the non-electrode portion 1136 as the inactive portion of the piezoelectric element 113 illustrated in FIG. 6 does not come into contact with the first elastic body 111. In addition, in the first example of the second exemplary embodiment, the relationship between the outer shape of the contact surface of the second elastic body 112 with the flexible printed board 114 and the piezoelectric element 113 is also similar to the relationship between the outer shape 1112 and the piezoelectric element 113 illustrated in FIG. 8A.

In a second example of the second exemplary embodiment illustrated in FIG. 8B, the outer shape 1112 of the contact surface of the first elastic body 111 with the piezoelectric element 113 is a circle, and an outer diameter of the circle is shorter than a length of one side of a rectangle (more specifically, square) that is the outer shape of the piezoelectric element 113. In addition, in the second example of the second exemplary embodiment, the relationship between the outer shape of the contact surface of the second elastic body 112 with the flexible printed board 114 and the piezoelectric element 113 is also similar to the relationship between the outer shape 1112 and the piezoelectric element 113 illustrated in FIG. 8B.

The second exemplary embodiment can also achieve effects similar to the effects by the above-described first exemplary embodiment.

### Third Exemplary Embodiment

A third exemplary embodiment is described. In description of the third exemplary embodiment described below, description of matters in common with the above-described first and second exemplary embodiments is omitted, and matters different from the above-described first and second exemplary embodiments are mainly described.

In the above-described first exemplary embodiment, the arrangement example of the inner-layer electrode 1135 in the piezoelectric element 113 illustrated in FIG. 6 is described. In the third exemplary embodiment, an arrangement example of the inner-layer electrode 1135 different from the arrangement example according to the first exemplary embodiment is described.

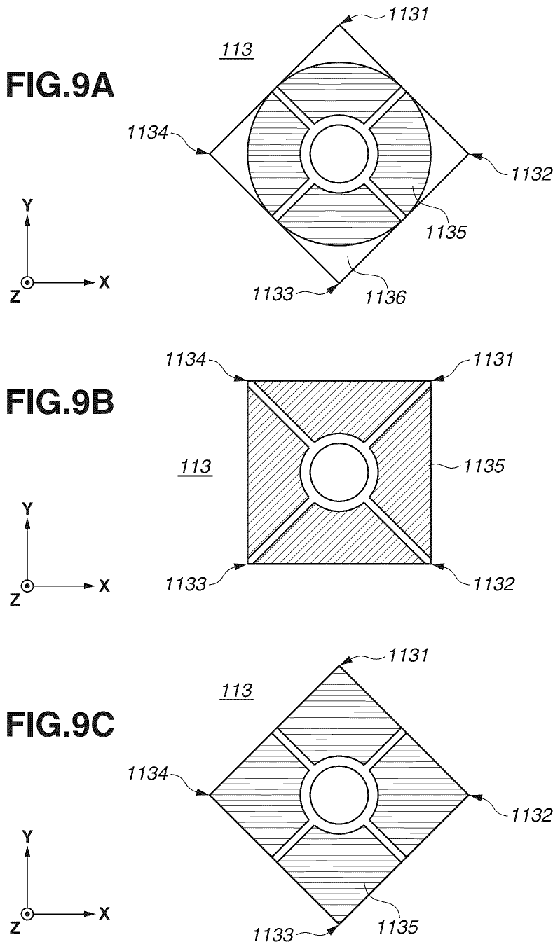

FIG. 9A to FIG. 9C are cross-sectional views of a cross-section (XY plane) of the piezoelectric element 113 perpendicular to the axis direction of the vibrator 110 (Z direction) according to the third exemplary embodiment of the present invention. In FIG. 9A to FIG. 9C, components similar to the components illustrated in FIG. 6 are denoted by the same reference numerals. Further, FIG. 9A to FIG. 9C illustrate an XYZ coordinate system corresponding to the XYZ coordinate system illustrated in FIG. 6.

In a first example of the third exemplary embodiment illustrated in FIG. 9A, the inner-layer electrode 1135 is divided into four parts by lines each connecting approximate middle points of sides facing each other of the rectangle (more specifically, square) that is the outer shape of the piezoelectric element 113. The first example of the third exemplary embodiment can also achieve effects similar to the effects by the above-described first exemplary embodiment.

In a second example of the third exemplary embodiment illustrated in FIG. 9B, the inner-layer electrode 1135 extends over the entire surface of the rectangle (more specifically, square) that is the outer shape of the piezoelectric element 113. In the second example of the third exemplary embodiment, as in the first exemplary embodiment illustrated in FIG. 6, the inner-layer electrode 1135 is disposed while being divided into four parts by diagonal lines connecting the vertices 1131 to 1134 of the rectangle that is the outer shape of the piezoelectric element 113. In the second example of the third exemplary embodiment illustrated in FIG. 9B, an amount of an electrode material is increased because the inner-layer electrode 1135 extends over the entire surface of the rectangle that is the outer shape of the piezoelectric element 113, but larger force can be generated as compared with the force by the first exemplary embodiment to the first example of the third exemplary embodiment described above.

In a third example of the third exemplary embodiment illustrated in FIG. 9C, as in the second example of the third exemplary embodiment illustrated in FIG. 9B, the inner-layer electrode 1135 extends over the entire surface of the rectangle (more specifically, square) that is the outer shape of the piezoelectric element 113. In the third example of the third exemplary embodiment, as in the first example of the third exemplary embodiment illustrated in FIG. 9A, the inner-layer electrode 1135 is divided into four parts by lines each connecting approximate middle points of sides facing each other of the rectangle (more specifically, square) that is the outer shape of the piezoelectric element 113. The third example of the third exemplary embodiment can also achieve effects similar to the effects by the second example of the third exemplary embodiment illustrated in FIG. 9B. In other words, the amount of the electrode material is increased because the inner-layer electrode 1135 extends over the entire surface of the rectangle that is the outer shape of the piezoelectric element 113, but larger force can be generated as compared with the first exemplary embodiment to the first example of the third exemplary embodiment described above.

### Fourth Exemplary Embodiment

A fourth exemplary embodiment is described. In description of the fourth exemplary embodiment described below, description of matters in common with the above-described first to third exemplary embodiments is omitted, and matters different from the above-described first to third exemplary embodiments are mainly described.

In the fourth exemplary embodiment, a driving apparatus that includes the vibration wave motor 100 according to any of the above-described first to third exemplary embodiments and is driven by the vibration wave motor 100 is described.

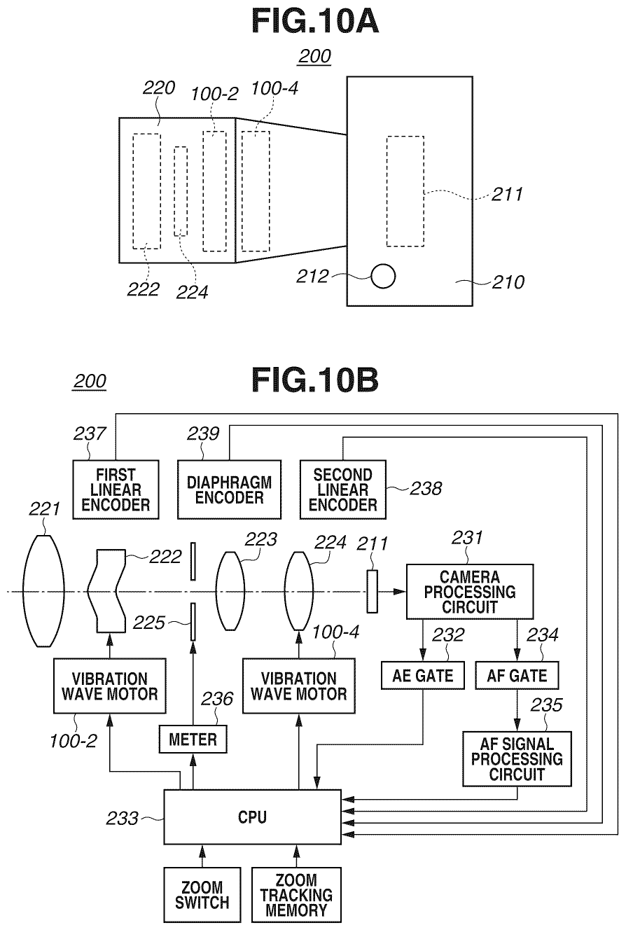

FIG. 10A and FIG. 10B are diagrams illustrating an example of a schematic configuration of an imaging apparatus 200 applied as the driving apparatus according to the fourth exemplary embodiment of the present invention. The vibration wave motor 100 according to any of the above-described first to third exemplary embodiments can be used, for example, for driving of lenses of the imaging apparatus (optical apparatus or electronic apparatus) 200. In the fourth exemplary embodiment, the imaging apparatus 200 including the vibration wave motor 100 that drives lens units as optical members disposed in a lens barrel 220 is described.

FIG. 10A is a top view illustrating an example of the schematic configuration of the imaging apparatus 200 applied as the driving apparatus according to the fourth exemplary embodiment. As illustrated in FIG. 10A, the imaging apparatus 200 includes a camera main body 210 and the lens barrel 220. The camera main body 210 includes an imaging element 211, a power supply button 212, and the like. The lens barrel 220 includes a first lens unit (not illustrated in FIG. 10A), a second lens unit 222, a third lens unit (not illustrated in FIG. 10A), a fourth lens unit 224, a vibration wave motor 100-2, a vibration wave motor 100-4, and the like. Each of the vibration wave motors 100-2 and 100-4 corresponds to the vibration wave motor 100 according to any of the above-described first to third exemplary embodiments, but may include other components such as a driving circuit in addition to the components of the vibration wave motor 100 according to any of the above-described first to third exemplary embodiments. In the imaging apparatus 200, the vibration wave motor 100-2 drives the second lens unit 222, and the vibration wave motor 100-4 drives the fourth lens unit 224. In the imaging apparatus 200, the lens barrel 220 is replaceable as an interchangeable lens, and the lens barrel 220 suitable for an imaging object can be attached to the camera main body 210.

In the vibration wave motor 100-2, a rotor including the contact body 120 and the rotor main ring 130 is disposed inside the lens barrel 220 such that a radial direction is substantially orthogonal to an optical axis (illustrated by alternate long and short dash line in FIG. 10B). In the vibration wave motor 100-2, the rotor including the contact body 120 and the rotor main ring 130 is rotated around the optical axis, and a rotational output of the contact body 120 is converted into rectilinear motion in the optical axis direction through the gear 160 and the like, thereby moving the second lens unit 222 in the optical axis direction. In the vibration wave motor 100-4, the fourth lens unit 224 is also moved in the optical axis direction by a configuration and operation similar to the configuration and the operation of the vibration wave motor 100-2.

FIG. 10B is a block diagram illustrating an example of the schematic configuration of the imaging apparatus 200 applied as the driving apparatus according to the fourth exemplary embodiment. In FIG. 10B, components similar to the components illustrated in FIG. 10A are denoted by the same reference numerals.

A first lens unit 221, the second lens unit 222, a third lens unit 223, the fourth lens unit 224, and a light quantity adjustment unit 225 illustrated in FIG. 10B are disposed at respective predetermined positions on the optical axis inside the lens barrel 220 illustrated in FIG. 10A. In FIG. 10B, light having passed through the first lens unit 221 to the fourth lens unit 224 and the light quantity adjustment unit 225 forms an image on an imaging element 211. The imaging element 211 converts an optical image into an electric signal, and outputs the electric signal to a camera processing circuit 231. The camera processing circuit 231 performs amplification, gamma correction, and the like on the electric signal output from the imaging element 211. The camera processing circuit 231 is connected to a central processing unit (CPU) 233 through an autoexposure (AE) gate 232, and connected to the CPU 233 through an autofocus (AF) gate 234 and an AF signal processing circuit 235. An image signal that is the electric signal subjected to the predetermined processing by the camera processing circuit 231 is transmitted to the CPU 233 through the AE gate 232, the AF gate 234, and the AF signal processing circuit 235. The AF signal processing circuit 235 extracts high-frequency components of the image signal, generates an evaluation value signal for autofocus (AF), and supplies the generated evaluation value signal to the CPU 233.

The CPU 233 is a control circuit controlling overall operation of the imaging apparatus 200, and generates control signals for determining of exposure and for focusing, from the acquired image signal. The CPU 233 controls driving of the vibration wave motor 100-2, the vibration wave motor 100-4, and a meter 236 in order to obtain the determined exposure and the appropriate focusing state. By the driving control of the vibration wave motor 100-2, the vibration wave motor 100-4, and the meter 236 by the CPU 233, the respective positions of the second lens unit 222, the fourth lens unit 224, and the light quantity adjustment unit 225 in the optical axis direction are adjusted. More specifically, the vibration wave motor 100-2 moves the second lens unit 222 in the optical axis direction under the control of the CPU 233. The vibration wave motor 100-4 moves the fourth lens unit 224 in the optical axis direction under the control of the CPU 233. The meter 236 moves the light quantity adjustment unit 225 in the optical axis direction under the control of the CPU 233.

The position in the optical axis direction, of the second lens unit 222 driven by the vibration wave motor 100-2 is detected by a first linear encoder 237, and a detection result is transmitted to the CPU 233 and is fed back to driving of the vibration wave motor 100-2. Likewise, the position in the optical axis direction, of the fourth lens unit 224 driven by the vibration wave motor 100-4 is detected by a second linear encoder 238, and a detection result is transmitted to the CPU 233 and is fed back to driving of the vibration wave motor 100-4. The position in the optical axis direction, of the light quantity adjustment unit 225 driven by the meter 236 is detected by a diaphragm encoder 239, and a detection result is transmitted to the CPU 233 and is fed back to driving of the meter 236.

The above-described exemplary embodiments of the present invention are merely specific examples for implementing the present invention, and the technical scope of the present invention is not limitedly interpreted thereby. In other words, the present invention can be implemented in various forms without departing from the technical idea or main features of the present invention.

Disclosure of the exemplary embodiments of the present invention includes the following configurations.

### [Configuration 1]

A vibration wave motor including:
a first elastic body and a second elastic body;
an electromechanical energy conversion element sandwiched between the first elastic body and the second elastic body; and
a contact body configured to come into pressure contact with the first elastic body, in which, in the electromechanical energy conversion element, an outer shape of a cross-section perpendicular to a pressure direction in the pressure contact is a rectangle, and in which vertices of the rectangle of the electromechanical energy conversion element are not in contact with the first elastic body.

### [Configuration 2]

The vibration wave motor according to configuration 1, in which the vertices of the rectangle of the electromechanical energy conversion element are not in contact with the second elastic body.

### [Configuration 3]

The vibration wave motor according to configuration 1 or 2, further including a flexible printed board provided between the electromechanical energy conversion element and the second elastic body,
in which a contact surface of the second elastic body with the flexible printed board is on an inside of the vertices of the rectangle of the electromechanical energy conversion element as viewed from the pressure direction.

### [Configuration 4]

The vibration wave motor according to configuration 3, in which an outer shape of the contact surface of the second elastic body with the flexible printed board is a circle.

### [Configuration 5]

The vibration wave motor according to configuration 3 or 4,
in which the first elastic body includes a first surface including a gap S1 between the first elastic body and the electromechanical energy conversion element, in an outer-shape neighborhood region of the outer shape of the electromechanical energy conversion element on the electromechanical energy conversion element side,
in which the second elastic body includes a second surface including a gap S2 between the second elastic body and the flexible printed board, in the outer-shape neighborhood region of the outer shape of the electromechanical energy conversion element on the flexible printed board side, and
in which a size of each of the gap S1 and the gap S2 is 20 μm or more and 200 μm or less.

### [Configuration 6]

The vibration wave motor according to any one of configurations 1 to 5, in which an outer shape of a contact surface of the first elastic body with the electromechanical energy conversion element is a circle.

### [Configuration 7]

The vibration wave motor according to any one of configurations 1 to 6, in which a neighborhood region including the vertices of the rectangle of the electromechanical energy conversion element is not polarized.

### [Configuration 8]

The vibration wave motor according to any one of configurations 1 to 7, in which a size of an outer diameter of at least one part of an inner-layer electrode of the electromechanical energy conversion element is coincident with a size of an outer diameter of a contact surface of the first elastic body with the electromechanical energy conversion element.

### [Configuration 9]

The vibration wave motor according to any one of configurations 1 to 8, in which a size of an outer diameter of at least one part of an inner-layer electrode of the electromechanical energy conversion element is coincident with a size of an outer diameter of a contact surface of the second elastic body with the electromechanical energy conversion element.

### [Configuration 10]

The vibration wave motor according to any one of configurations 1 to 9, in which the rectangle of the electromechanical energy conversion element is a square.

### [Configuration 11]

The vibration wave motor according to any one of configurations 1 to 10, further including a thin plate provided between the first elastic body and the electromechanical energy conversion element, and having a thickness of 20 μm or more and 200 μm or less, the thin plate being not in contact with the vertices of the rectangle of the electromechanical energy conversion element.

### [Configuration 12]

A driving apparatus including:
the vibration wave motor according to any one of configurations 1 to 11; and
a member configured to be driven by the vibration wave motor.

### [Configuration 13]

The driving apparatus according to configuration 12, in which the member is a lens.

The present invention is not limited to the above-described exemplary embodiments, and can be variously changed and modified without departing from the spirit and the scope of the present invention. Therefore, to apprise the public of the scope of the present invention, the following claims are made.

According to the present invention, it is possible to provide the vibration wave motor that can efficiently perform vibration while reducing a manufacturing cost.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A vibration wave motor comprising:
a first elastic body and a second elastic body;
an electromechanical energy conversion element sandwiched between the first elastic body and the second elastic body; and
a contact body configured to come into pressure contact with the first elastic body,
wherein, in the electromechanical energy conversion element, an outer shape of a cross-section perpendicular to a pressure direction is a rectangle,
wherein a gap is provided at a position where the electromechanical energy conversion element and the first elastic body face each other in the pressure direction, and
wherein a vertex of the rectangle of the electromechanical energy conversion element is not in contact with the first elastic body at the gap.

2. The vibration wave motor according to claim 1, vertices of the rectangle are not in contact with the first elastic body at the gap.

3. The vibration wave motor according to claim 1, wherein a vertex of the rectangle of the electromechanical energy conversion element is not in contact with the second elastic body.

4. The vibration wave motor according to claim 3, wherein vertices of the rectangle are not in contact with the second elastic body.

5. The vibration wave motor according to claim 1, further comprising a flexible printed board provided between the electromechanical energy conversion element and the second elastic body,
wherein a contact surface of the second elastic body with the flexible printed board is on an inside of the vertices of the rectangle of the electromechanical energy conversion element as viewed from the pressure direction.

6. The vibration wave motor according to claim 5, wherein an outer shape of the contact surface of the second elastic body with the flexible printed board is a circle.

7. The vibration wave motor according to claim 5,
wherein the first elastic body includes a first surface including a gap S1 as the gap between the first elastic body and the electromechanical energy conversion element, in an outer-shape neighborhood region of the outer shape of the electromechanical energy conversion element on the electromechanical energy conversion element side,
wherein the second elastic body includes a second surface including a gap S2 between the second elastic body and the flexible printed board, in the outer-shape neighborhood region of the outer shape of the electromechanical energy conversion element on the flexible printed board side, and
wherein a size of each of the gap S1 and the gap S2 is 20 μm or more and 200 μm or less.

8. The vibration wave motor according to claim 1, wherein an outer shape of a contact surface of the first elastic body with the electromechanical energy conversion element is a circle.

9. The vibration wave motor according to claim 1, wherein a neighborhood region including the vertices of the rectangle of the electromechanical energy conversion element is not polarized.

10. The vibration wave motor according to claim 1, wherein a size of an outer diameter of at least one part of an inner-layer electrode of the electromechanical energy conversion element is coincident with a size of an outer diameter of a contact surface of the first elastic body with the electromechanical energy conversion element.

11. The vibration wave motor according to claim 1, wherein a size of an outer diameter of at least one part of an inner-layer electrode of the electromechanical energy conversion element is coincident with a size of an outer diameter of a contact surface of the second elastic body with the electromechanical energy conversion element.

12. The vibration wave motor according to claim 1, wherein the rectangle of the electromechanical energy conversion element is a square.

13. The vibration wave motor according to claim 1, further comprising a thin plate provided between the first elastic body and the electromechanical energy conversion element, and having a thickness of 20 μm or more and 200 μm or less, the thin plate being not in contact with the vertices of the rectangle of the electromechanical energy conversion element.

14. A driving apparatus comprising:
the vibration wave motor according to claim 1; and
a member configured to be driven by the vibration wave motor.

15. The driving apparatus according to claim 14, wherein the member is a lens.

16. An electronic apparatus comprising:
the vibration wave motor according to claim 1; and
a member configured to be driven by the vibration wave motor.
